(19) United States
(12) Patent Application Publication
(10) Pub. No.: US 2005/0207327 A1
(43) Pub. Date: Sep. 22, 2005

(54) Recording method using reaction and diffusion, recording medium recorded on using the recording method, and recording/reproducing apparatus for the recording medium

(76) Inventors: Joo-Ho Kim, Ibaraki (JP); Junji Tominaga, Ibaraki (JP)

Correspondence Address: STEIN, MCEWEN & BUI, LLP, 1400 EYE STREET, NW, SUITE 300, WASHINGTON, DC, 20005, US

(21) Appl. No.: 10/509,367

(22) PCT Filed: Mar. 28, 2003
(86) PCT No.: PCT/KR03/00625

§ 371 Date: May 17, 2005

(30) Foreign Application Priority Data
Mar. 28, 2002 (JP) 2002-92662

(51) Int. Cl. G11B 7/24

(52) U.S. Cl. 369/288

(57) ABSTRACT

A phase change and/or magneto-optical recording method using laser induced reaction and diffraction in a recording layer and a dielectric layer of a recording medium involves changing absorption coefficients of optical constants of a recording layer and a dielectric layer of a recording medium by laser induced reaction and diffusion. The magneto-optical recording method involves changing the magnetization direction in a recording layer while the recording layer and a dielectric layer of a recording medium are irradiated with a laser inducing reaction and diffusion therein.

### CROSS-REFERENCE TO RELATED APPLICATIONS

This application is a National Stage of PCT Application No. PCT/KR2003/625, filed Mar. 28, 2003 in the World Intellectual Property Office, and Japanese Patent Application No. 2002-92662 filed on Mar. 28, 2002 in the Japanese Patent Office, the disclosures of which are incorporated herein by reference.

### BACKGROUND OF THE INVENTION

1. Field of the Invention

The present invention relates to a recording method using reaction and diffusion, a recording medium recorded on using the recording method, and a recording/reproducing apparatus for the recording medium. More particularly, the present invention relates to, a recording method using reaction and diffusion induced in a dielectric layer and a recording layer formed of a rare earth transition metal or alloys of rare earth metal and transition metal and transition metal by laser irradiation and enabling phase change recording and/or magneto-optical recording, a recording medium recorded on using the method, and a recording/reproducing apparatus for recording information on and reproducing information from the recording medium.

2. Description of the Related Art

Conventional recording media can be classified into magneto-optical recording media or phase change recording media. In magneto-optical recording media, such as mini disks (MDs), information is read by detecting the rotation of incident straight polarized light reflected from a magnetic film according to the magnetic force and the magnetization direction of the magnetic film. The rotation of the reflected light is known as the “Kerr Effect”. In phase change recording media, such as digital versatile discs (DVDs), information is read based on the difference in reflectivity due to the different absorption coefficients of an optical constant between an amorphous recorded area and a crystalline non-recorded area of the recording medium.

FIG. 1 illustrates a conventional magneto-optical recording medium and the recording principle thereof. Referring to FIG. 1, a magneto-optical recording medium includes an aluminum (Al) layer 111 as a reflective layer (the reflective layer may also be formed of silver (Ag)), a dielectric layer 112 formed of, for example, SiN, a magnetic recording layer 113 formed of TbFeCo, a dielectric layer 114 formed of, for example, SiN, and a transparent polycarbonate layer 115, which are sequentially stacked upon one another. This recording medium is irradiated with a laser beam of about 5 mW emitted from a laser source 118 through a focusing lens 119 and a magnetic coil 116 to which a current is applied using a current source 117, so that the recording layer 113 is heated to a temperature of 200-400° C., and a magnetic field is generated in the laser-irradiated area. As a result, the laser-irradiated area is magnetized in a direction opposite to a non-laser-irradiated area. Magneto-optically recorded information can be magneto-optically reproduced. In FIG. 1, the magnetization direction, in the non-recorded area and the recorded area, is denoted by downward and upward arrows, respectively.

FIG. 2 illustrates a conventional phase change recording medium and the recording principle thereof. Referring to FIG. 2, a phase change recording medium includes an aluminum (Al) layer 121 as a reflective layer, (the reflective layer may also be formed of Ag), a dielectric layer 122 formed of, for example, ZnS—SiO2, a recording layer 123 formed of, for example, GaSbTe, a dielectric layer 124 formed of, for example, ZnS-SiO2, and a transparent carbonate layer 125, which are sequentially stacked upon one another. The phase change recording medium may further include a protective layer (not shown) between the recording layer 123 and each of the dielectric layers 123 and 124 so as to block a reaction diffusion between these layers. The phase change recording medium is irradiated with a laser beam of about 10-15 mW emitted from a laser source 128 through a focusing lens 129 so that the recording layer 122 is heated to about 600° C., and a laser-irradiated area becomes amorphous. This amorphous laser-irradiated area has a reduced absorption coefficient k regardless of the change of refractive index n of an optical constant (n, k). The information recorded by phase change can be reproduced by phase change. The reduction of the absorption coefficient k means that the amorphous area on which information is recorded by laser irradiation becomes more transparent and has a smaller reflectivity. In general, the absorption coefficient is about 3.0 for a crystalline, non-recorded area of the recording layer and about 1.5 for an amorphous, laser-irradiated recorded area.

The principles of magneto-optical recording and phase change recording are distinct from one another, therefore they can be implemented only on one specific recording media.

Many diversified methods of recording information using micro marks (pits) as in the phase change method and reproducing information from the recording medium regardless of the diffraction limit have been suggested. The most interested one among these methods is a reproducing method using a super-resolution near-field structure, which is disclosed in Applied Physics Letters, Vol. 73, No. 15, Oct. 1998, and Japanese Journal of Applied Physics, Vol. 39, Part I, No. 2B, 2000, pp. 980-981.

FIG. 3 shows a conventional recording medium having a super-resolution near-field structure. Referring to FIG. 3, the recording medium includes a dielectric layer 132-2 formed of, for example, ZnS—SiO2, a recording layer 133 formed of, for example, GeSbTe, a dielectric layer 134-2 as a protective layer formed of, for example, ZnS—SiO2 or SiN, a mask layer 137-2 formed of, for example, Sb or AgOx, a dielectric layer 134-1 formed of, for example, ZnS—SiO2 or SiN, and a transparent polycarbonate layer 135, which are sequentially stacked upon one another. When the mask layer 137-2 is formed of Sb, the dielectric layers 134-1 and 134-2 contacting the mask layer 137-2 are formed of SiN. When the mask layer 137-2 is formed of AgOx, the dielectric layers 134-1 and 134-2 contacting the mask layer 137-2 are formed of ZnS—SiO2. The recording medium is irradiated with a laser beam of about 10-15 mW emitted from a laser source 138 through a focusing lens 139 so that the recording layer 133 is heated to about 600° C., and a laser-irradiated area becomes amorphous and has a smaller absorption coefficient k regardless of the change of refractive index n of an optical constant (n,k). In an irradiated area of the Sb or AgOx mask layer 137-2, the crystalline structure of Sb changes or AgOx decomposes, generating a probe as a near-field structure pointing at a region of the recording layer 133. As a result, information recorded on high-density recording media, which is recorded as micro marks that go beyond the diffraction limit, can be reproduced using such a super-resolution near-field structure.

However, in recording media having such a super-resolution near-field structure, since their mask layer and recording layer have similar transition temperatures, ensuring thermal stability to both, the mask layer and the recording layer during reproduction of information, is considered important. Possible solutions to this problem include dropping the transition temperature of the mask layer and raising the transition temperature of the recording layer. However, it is not easy to make the difference in transition temperature between the mask layer and the recording layer larger due to the nature of the materials forming the two layers.

### SUMMARY OF THE INVENTION

An aspect of the present invention provides a recording method using reaction and diffusion induced in a dielectric layer and a recording layer by laser irradiation and enabling phase change recording and/or magneto-optical recording, a recording medium recorded on using the recording method, and a recording and reproducing apparatus recording information on and reproducing information from the recording medium. Information can be reproduced from the recording medium according to the present invention using either a magneto-optical reproducing method or a phase change reproducing method. The problem of thermal instability occurring in the conventional super-resolution near-field recording media during reproduction, due to the similar transition temperatures of their mask layer and recording layer, is eliminated, so that information recorded on the recording medium according to the present invention can be reproduced regardless of the diffraction limit.

In accordance with one aspect of the present invention, there is provided is a phase change method of recording information on a recording medium by changing absorption coefficients of optical constants of a recording layer and a dielectric layer of the recording medium by laser induced reaction and diffusion.

According to another aspect of the present invention, the recording layer is formed of a rare earth transition metal. In this case, the rare earth transition metal may be TbFeCo.

According to another aspect of the present invention, the recording layer is formed of alloys of rare earth metal and transition metal.

According to another aspect of the present invention, the reaction and diffusion are induced at a temperature of 490-580° C.

According to another aspect of the present invention, when the dielectric layer of the recording medium is constructed as a sequential stack of a protective dielectric layer, a mask layer formed of Sb, and a dielectric layer, laser light is radiated to induce reaction and diffusion in the recording layer and the protective dielectric layer and change the crystalline structure of the mask layer, so that information can be reproduced from the recording medium regardless of a diffraction limit6.

According to another aspect of the present invention, when the dielectric layer of the recording medium is constructed as a sequential stack of a protective dielectric layer, a mask layer formed of AgOx stacked, and a dielectric layer, laser light is radiated to induce reaction and diffusion in the recording layer and the protective dielectric layer and decompose the mask layer, so that information can be reproduced from the recording medium regardless of a diffraction limit.

According to another aspect of the present invention, the recording layer and the dielectric layer are simultaneously formed, so that the recording layer and the dielectric layer have a mixed structure including materials for the recording layer and the dielectric layer.

In accordance with another aspect of the present invention, there is provided a magneto-optical method of recording information on a recording medium by changing the magnetic spin direction in a recording layer while the recording layer and a dielectric layer of the recording medium are irradiated with laser to induce reaction and diffusion therein.

According to an aspect of the present invention, the recording layer and the dielectric layer are simultaneously formed, so that the recording layer and the dielectric layer have a mixed structure including materials for the recording layer and the dielectric layer.

According to another aspect of the present invention, the recording layer is formed of a rare earth transition metal. In this case, the rare earth transition metal may be TbFeCo.

According to another aspect of the present invention, the recording layer is formed of alloys of rare earth metal and transition metal.

According to another aspect of the present invention, the reaction and diffusion are induced at a temperature of 400-490° C.

In accordance with another aspect of the present invention, there is provided a recording method based on the physical properties of protruding record marks formed by laser induced reaction and diffusion in a recording layer and a dielectric layer.

According to an aspect of the present invention, the recording layer is formed of a rare earth transition metal. In this case, the rare earth transition metal may be TbFeCo.

According to another aspect of the present invention, the recording layer is formed of alloys of rare earth metal and transition metal.

According to another aspect of the present invention, the reaction and diffusion are induced at a temperature of 400-490° C.

According to another aspect of the present invention, when the dielectric layer of the recording medium is constructed as a sequential stack of a protective dielectric layer, a mask layer formed of Sb, and a dielectric layer, laser light is radiated to induce reaction and diffusion in the recording layer and the protective dielectric layer and change the crystalline structure of the mask layer, so that information can be reproduced from the recording medium regardless of a diffraction limit.

According to another aspect of the present invention, when the dielectric layer of the recording medium is constructed as a sequential stack of a protective dielectric layer, a mask layer formed of AgOₓ, and a dielectric layer on the recording layer, laser light is radiated to induce reaction and diffusion in the recording layer and the protective dielectric layer and decompose the mask layer, so that information can be reproduced from the recording medium regardless of a diffraction limit.

According to another aspect of the present invention, the recording layer and the dielectric layer are simultaneously formed, so that the recording layer and the dielectric layer have a mixed structure including materials for the recording layer and the dielectric layer.

In accordance with another aspect to the present invention, there are provided recording media recorded on using the recording method discussed above.

In accordance with another aspect to the present invention, there are provided recording and reproducing apparatuses for the recording medium. A recording and reproducing apparatus according to the present invention is either a phase change recording and reproducing apparatus or a magneto-optical recording and reproducing apparatus. A recording and reproducing apparatus according to an aspect of the present invention can reproduce information recorded on a recording medium using a phase change reproducing method and a magneto-optical reproducing method. A recording and reproducing apparatus according to an aspect of the present invention records and reproduces information based on the physical properties of protruding record marks formed by laser induced reaction and diffusion in a recording layer and a dielectric layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional magneto-optical recording medium and the recording principle thereof;

FIG. 2 illustrates a conventional phase change recording medium and the recording principles thereof;

FIG. 3 shows a conventional recording medium having a super-resolution near-field structure;

FIG. 4 shows the structure of a recording medium according to an aspect of the present invention;

FIG. 5 shows a change in the structure of a recording layer and a dielectric layer of the recording medium according to an aspect of the present invention as a result of reactions and diffusion therein;

FIGS. 6A and 6B are graphs showing diffusion concentration of sulfur and oxygen, respectively, into a recording layer at different temperatures;

FIGS. 7A through 7C illustrate the performance of the recording medium according to aspects of the present invention;

FIGS. 8A through 8D show the performance of a recording medium having a super-resolution near-field structure according to aspects of the present invention;

FIG. 9A is a graph of CNR when using phase change reproduction and magneto-optical reproduction methods to reproduce information recorded as marks by the phase change method according to an aspect of the present invention; and

FIG. 9B is a graph of CNR when using phase change reproduction and magneto-optical reproduction methods to reproduce information recorded as marks by the phase change and magneto-optical methods according to an aspect of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

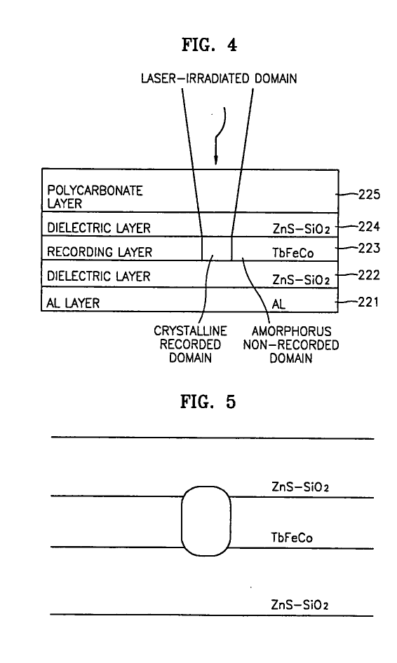

The structure of a recording medium according to an aspect of the present invention is shown in FIG. 4. Referring to FIG. 4, a recording medium according to the present invention includes an aluminum (Al) layer 221 acting as a reflective layer, which may also be formed of silver (Ag), a dielectric layer 222 formed of, for example, ZnS—SiO₂, a magnetic recording layer 223 formed of a material having a large affinity and reactivity to oxygen and sulfur, for example, TbFeCo, a dielectric layer 224 formed of, for example, ZnS—SiO₂, and a transparent polycarbonate layer 225. The layers forming the recording medium are sequentially stacked upon one another. A material for the recording layer 223 should be capable of forming sulfides or oxides by diffusion into and reaction with the dielectric layer 222, like rare earth transition metals or alloys of rare earth metal and transition metals. Examples of such a material include a magneto-optical material, Ag—Zn, W, W—Fe, W—Se, Fe, etc.

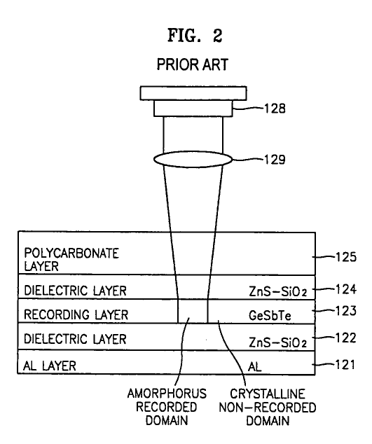

In the recording medium having the structure of FIG. 4, information can be recorded using phase change, as described with reference FIG. 2. In particular, the recording medium is irradiated with a 635-nm red laser beam or a 405-nm blue laser beam having an output power of 10-15 mW emitted from the laser source 128 (refer to FIG. 2) through the focusing lens 129, so that the recording layer 223 is heated to a temperature of 490-540° C. to induce reactions and diffusion in the recording layer 223 and the dielectric layers 222 and 224. A laser-irradiated area of the recording layer 223, where reactions and diffusion have occurred, has a smaller absorption coefficient k of an optical constant (n,k) that is nearly zero, compared with a non-irradiated area of the recording layer having an absorption coefficient k of about 4. Accordingly, information can be recorded on the recording medium using phase change.

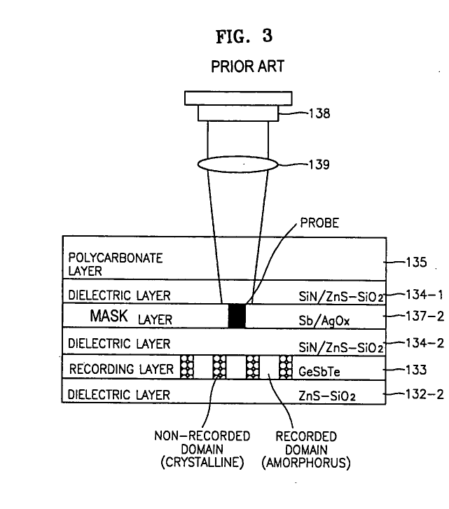

Another embodiment of the recording medium according to the present invention has a super-resolution near-field structure as shown in FIG. 3. In this case, the aluminum layer 221 acting as a reflective layer is removed from the recording medium of FIG. 4, and a protective dielectric layer, a Sb or AgOₓ mask layer, and another dielectric layer are sequentially deposited on the recording layer 223, instead of the dielectric layer 224. When this recording medium is irradiated with laser light, reactions and diffusion occur in the recording layer 223 and the protective dielectric layer. At this time, the crystalline structure of Sb changes when the mask layer is formed of Sb, and the mask layer decomposes when it is formed of AgOₓ. Due to these phenomena in the recording medium, recorded information can be reproduced regardless of the diffraction limit. In addition, since the difference in transition temperature between the Sb or AgOₓ mask layer and the TbFeCo recording layer is large, information can be reproduced without conventional thermal instability problems. A region of the mask layer that undergoes the crystalline change serves as a probe. When the mask layer is formed of Sb, the protective dielectric layer and the dielectric layer on the mask layer are formed of SiN. When the mask layer is formed of AgOₓ, the protective dielectric layer and the dielectric layer on the mask layer are formed of ZnS—SiO₂.

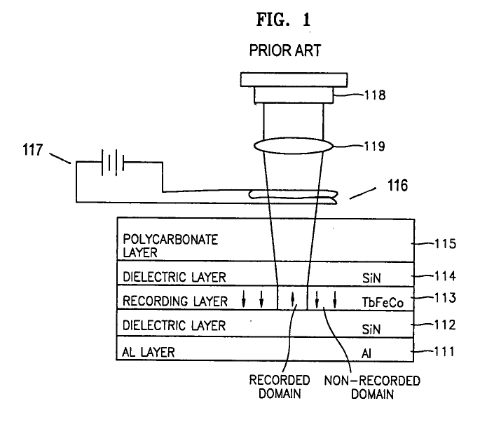

In the recording medium having the structure of FIG. 4, information can be recorded using a magneto-optical method, as described with reference to FIG. 1. In particular, the recording medium is irradiated with a 635-nm red laser beam or a 405-nm blue laser beam having an output power of 10-15 mW emitted from the laser source 118 (refer to FIG. 1) through the focusing lens 119, so that the recording layer is heated to a temperature of 400-490° C. to induce reactions and diffusion in the recording layer 223 and the dielectric layers 222 and 224. Since the laser beam is radiated through the magnetic coil 116 to which a current is applied from the current source 117, a magnetic field having a magnetization direction opposite to a non-laser-irradiated area is generated in a laser-irradiated area. Here, reactions obviously occur in the recording layer 223 and the dielectric layers 222 and 224, but diffusion does not. Since the laser-irradiated area of the recording medium, where reactions and diffusion occurred, and the non-laser-irradiated area are magnetized in opposite directions, information can be magneto-optically recorded.

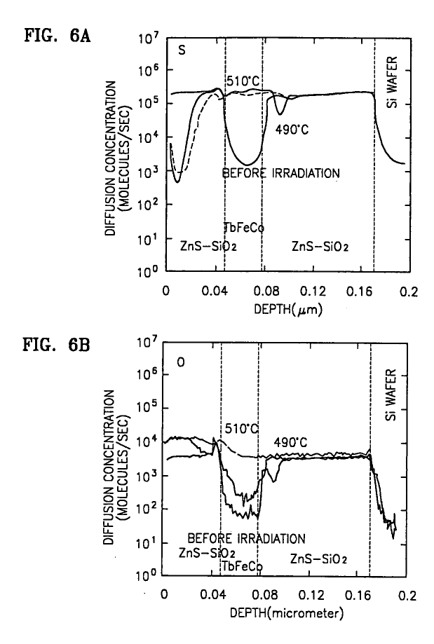

When recording information in the recording medium having the structure of FIG. 4 using phase change, the recording layer can be heated to a temperature of 400-490° C. to induce reactions and diffusion in the recording layer 223 and the dielectric layers 222 and 224 by the irradiation of 635-nm red laser light or 405-nm blue laser light having an output power of 10-15 mW emitted from the laser source 128, as illustrated in FIG. 2. In this case, only reactions occur, but diffusion does not. In a laser-irradiated area of the recording layer 223 and the dielectric layers 222 and 224, a physical deformation, as illustrated in FIG. 5, occurs as a result of the reaction and diffusion in the recording layer 223 and the dielectric layers 222 and 224. Such a physical deformation resulting from the reaction, leading to a protruding record mark, in the laser-irradiated area reflects an incident laser beam at a similar angle to the reflection angle of reproducing light used in a magneto-optical reproducing apparatus. In other words, due to the physical properties of the protruding record mark formed as a result of the reaction in the laser-irradiated area, information can be recorded on the recording medium by phase change and can be reproduced from the same using a magneto-optical recording/reproducing apparatus. These recording and reproducing operations will be described later.

In the TbFeCo recording layer 223 and the ZnS—SiO₂ dielectric layers 222 and 224 of the recording medium according to the present invention, Tb₂S₃, FeS, CoS, CoS₂ and CO₂S₃ are derived as a result of sulfurization, TbO₂, Tb₂O₃, FeO, Fe₂O₃, Fe₃O₄, and CoO are derived as a result of oxidation, and α-Fe, α-Co, α-Tb and α—Fe—Tb are generated as a result of crystallization. Si, Fe, and Co diffuse between the recording layer 223 and the dielectric layer 222 and 224, and sulfur and oxygen diffuse into the recording layer 223.

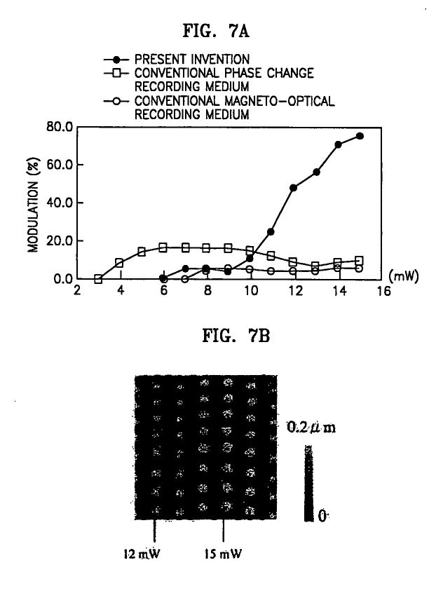

FIGS. 6A and 6B are graphs of diffusion concentration of sulfur and oxygen, respectively, into the recording layer versus temperature. The concentration of sulfur in the recording layer is saturated at 490° C. and 510° C., as shown in FIG. 6A. The concentration of oxygen in the recording layer is not saturated at 490° C. but is saturated at 510° C., as shown in FIG. 6B. When a recording medium according to an aspect of the present invention is manufactured with a super-resolution near-field structure as shown in FIG. 3, in which the recording layer is formed of a rare earth transition metal or alloys of rare earth metal and transition metal, since the transition temperature of the recording layer is greatly different from the transition temperature of the Sb or AgOₓ mask layer, information recorded on the recording medium can be reproduced regardless of the diffraction limit, without thermal instability problems occurring in conventional super-resolution near-field recording media.

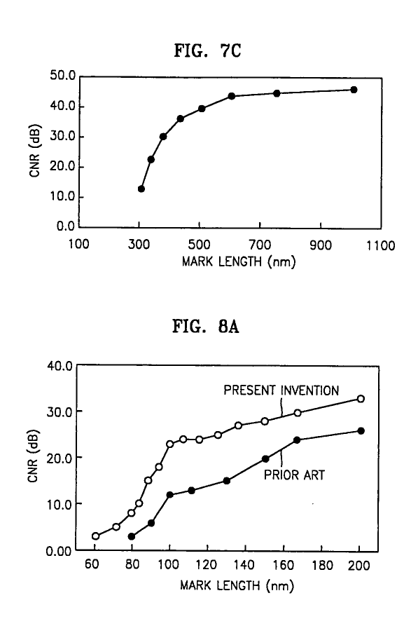

FIGS. 7A through 7C show the performance of a recording medium according to the present invention, in which FIG. 7A shows modulation characteristic versus recording power, FIG. 7B is an atomic force microscopic (AFM) photograph of a recording medium sample used for the modulation measurement, and FIG. 7C shows carrier to noise ratio (CNR) versus mark length. The modulation characteristic of FIG. 7A was measured by converting the difference in reflectivity due to the different absorption coefficients k between the irradiated and non-irradiated areas into an electrical signal. The CNR of FIG. 7C was measured while reproducing information recorded on the recording medium according to an aspect of the present invention by irradiation of a laser beam of 15 mW using a general phase change reproducing apparatus.

As shown in FIG. 7A, the recording medium according to an aspect of the present invention, where the recording layer formed of TbFeCo is interposed between the dielectric layers formed of ZnSiO₂, shows good modulation characteristic at a recording power of about 10 mW or greater, compared with a conventional phase change recording medium having a recording layer formed of GeSbTe between dielectric layers formed of ZnSiO₂ and a conventional magneto-optical recording medium having a recording layer formed of TbFeCo between dielectric layers formed of SiN. As shown in FIG. 7B, larger record marks appear in the recording medium due to a greater degree of reactivity of the recording layer with increasing recording power. As shown in FIG. 7C, the CNR is 45 dB or greater at a mark length of 500 nm. This good information reproduction property is attributed to a sharp drop in reflectivity rendering the laser-irradiated area transparent.

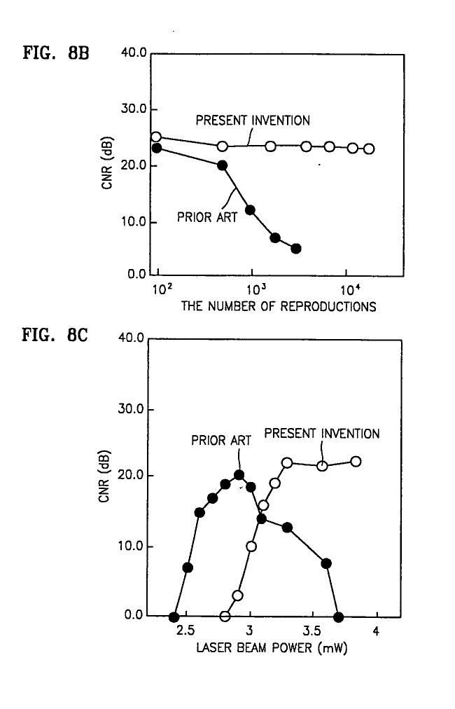

FIGS. 8A through 8D illustrates the performance of a recording medium according to the present invention having a super-resolution near-field structure. FIG. 8A shows CNR versus mark length; FIG. 8B shows CNR versus the number of reproductions; FIG. 8C shows CNR versus the power of reproducing laser light; and FIG. 8D is a top view showing the shapes of record marks in the recording medium. The super-resolution near-field structure of the recording medium of an aspect of the present invention is the same as the conventional super-resolution near-field structure of FIG. 3, with the exception of the recording layer formed of a rare earth transition metal, TbFeCo. Recording was performing using 635-nm red laser light having an output power of 10 mW for the conventional recording medium and 15 mW for the recording medium according to the present invention.

Comparing information reproduction properties between the super-resolution near-field recording medium according to an aspect of the present invention and the reproduction properties of a conventional recording medium, as shown in FIG. 8A, the CNR is about 5-10 dB higher for all of the mark lengths in the recording medium according to an aspect of the present invention, indicating that the super-resolution near-field recording medium according to an aspect of the present invention provides better information reproduction properties than the conventional one. Referring to FIG. 8B, it is apparent that the information reproduction properties, which are measured as CNR, of the super-resolution near-field recording medium according to the present invention remain constant regardless of how much reproducing operations are repeated, whereas the information reproduction properties of the conventional recording medium remarkably degrade after the reproduction is repeated a certain number of times. FIG. 8C shows that the information reproduction properties of the super-resolution near-field recording medium according to the present invention remain constant at a reproducing laser power of 3.3 mW or greater, whereas the information reproduction properties of the conventional recording medium sharply degrade at a predetermined reproducing laser power without a small tolerance. Accordingly, the super-resolution near-field recording medium according to an aspect of the present invention can be reproduced by any reproducing apparatus manufactured by different makers, without degradation of reproduction properties, even at a higher reproducing power. Referring to FIG. 8D, record marks of 200 nm are seen as distinct. It is also expected that information can be recorded as marks having a length of 100 nm or less using 405-nm blue laser light.

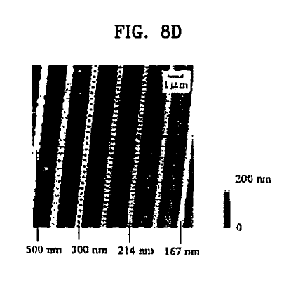

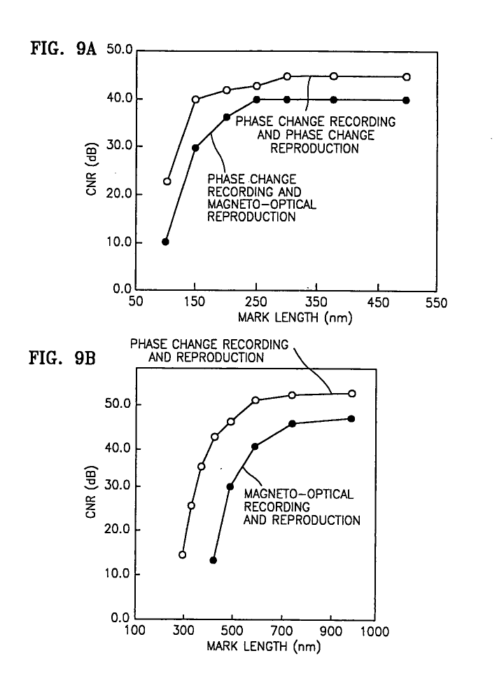

FIG. 9A is a graph of CNR when using phase change reproduction and magneto-optical reproduction methods to reproduce information recorded as marks by the phase change method according to an aspect of the present invention. FIG. 9B is a graph of CNR when using phase change reproduction and magneto-optical reproduction methods to reproduce information recorded as marks by the phase change and magneto-optical methods according to an aspect of the present invention. For the CNR measurement of FIG. 9A, phase change reproducing and magneto-optical reproducing apparatuses manufactured by Pulse Tec. Co. (Japan) were used. For the CNR measurement of FIG. 9B, a general phase change reproducing apparatus using 630-nm light and a lens having a 0.60-numerical aperture (NA) and a general magneto-optical reproducing apparatus using 780-nm light and a lens having a 0.53-NA were used.

Referring to FIG. 9A, for mark lengths of 250 nm or greater, the CNR is about 40 dB or greater both when the phase change reproducing apparatus is used and when the magneto-optical reproducing apparatus is used. Therefore, the recording medium according to the present invention is compatible with both, the phase change reproducing apparatus and the magneto-optical reproducing apparatus. The physical characteristics of the laser-irradiated area, where record bumps are formed by reaction and diffusion, i.e., the reflection angle of laser light at the record bump with respect to incident angle that provides a similar effect to the Kerr effect, are thought as enabling the magneto-optical reproduction. When recording information by laser induced reaction and diffusion, an additional magnetic coil commonly used in conventional magneto-optical recording can be used to change the magnetization direction. In this case, information can be reproduced at a higher CNR.

Although a magneto-optical recording apparatus using 780-nm laser light and a lens having a 0.53 NA was used for the measurement of FIG. 9B, nearly the same performance as when using the phase change reproducing apparatus can be achieved by changing the wavelength of the reproducing laser light and the NA applied in the magneto-optical recording apparatus to 630 nm and 0.60, respectively, which are the same as those used in the phase change reproducing apparatus. For a mark length of 400 nm, the CNR is about 40 dB or greater both when the phase change reproducing apparatus is used and when the magneto-optical reproducing apparatus is used. Apparently, the recording medium according to the present invention is compatible with both, the phase change recording apparatus and the magneto-optical reproducing apparatus.

As described above, in a recording method according to an aspect of the present invention, reactions and diffusion are induced in the dielectric layers and the recording layer of a recording medium by laser irradiation and enable phase change recording and/or magneto-optical recording. When information is recorded on the recording medium according to the method of the present invention and reproduced using information recording and reproducing apparatuses according to the present invention, information reproduction properties are improved compared with conventional techniques. In addition, a recording medium according to an aspect of the present invention, recorded on using the above method based on phase change recording and magneto-optical recording principles, is compatible with both the phase change reproducing apparatus and the magneto-optical reproducing apparatus. Furthermore, the problem of thermal degradation occurring in conventional super-resolution near-field recording media due to similar transition temperatures of their mask layer and recording layer is resolved, so that information can be reproduced from a super-resolution near-field recording medium according to the present invention regardless of the diffraction limit.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of recording information on a phase change recording medium comprising: changing absorption coefficients of optical constants of a recording layer and a dielectric layer of the recording medium using laser induced reaction and diffusion.

2. The method of claim 1, wherein the recording layer is formed of a rare earth transition metal.

3. The method of claim 2, wherein the rare earth transition metal is TbFeCo.

4. The method of claim 41, wherein the recording layer is formed of alloys of rare earth metal and transition metal.

5. The method of any claim 1, wherein the reaction and diffusion are induced at a temperature of at or between 490 and 580° C.

6. The method claim 1, wherein, when a protective dielectric layer, a mask layer formed of Sb, and the dielectric layer are sequentially formed on the recording layer, laser light is radiated to induce reaction and diffusion in the recording layer and the protective dielectric layer and to induce change in a crystalline structure of the mask layer, so that information can be reproduced from the recording medium regardless of a diffraction limit.

7. The method of claim 1, wherein, when a protective dielectric layer, a mask layer formed of AgOₓ, and the dielectric layer are sequentially stacked on the recording layer, laser light is radiated to induce reaction and diffusion in the recording layer and the protective dielectric layer and decompose the mask layer, so that information can be reproduced from the recording medium regardless of a diffraction limit.

8. The method of claim 1, wherein the recording layer and the dielectric layer are simultaneously formed, so that the recording layer and the dielectric layer have a mixed structure including materials for the recording layer and the dielectric layer.

9. A method of recording information on a magneto-optical recording medium comprising: changing a magnetic spin direction in a recording layer while the recording layer and a dielectric layer of the recording medium are irradiated with laser to induce reaction and diffusion therein.

10. The method of claim 9, wherein the recording layer and the dielectric layer are simultaneously formed, so that the recording layer and the dielectric layer have a mixed structure including materials for the recording layer and the dielectric layer.

11. The method of claim 9, wherein the recording layer is formed of a rare earth transition metal.

12. The method of claim 11, wherein the rare earth transition metal is TbFeCo.

13. The method of claim 9, wherein the recording layer is formed of alloys of rare earth metal and transition metal.

14. The method of claim 9, wherein the reaction and diffusion are induced at a temperature of at or between 400- and 490° C.

15. A method of recording information on a recording medium based on physical properties of protruding record marks comprising laser inducing reaction and diffusion in a recording layer and a dielectric layer of the recording medium.

16. The method of claim 15, wherein the recording layer is formed of a rare earth transition metal.

17. The method of claim 16, wherein the rare earth transition metal is TbFeCo.

18. The method of claim 15, wherein the recording layer is formed of alloys of rare earth metal and transition metal.

19. The method of claim 15, wherein the reaction and diffusion are induced at a temperature of at or between 400° C. and 490° C.

20. The method of claim 15, wherein, when a protective dielectric layer, a mask layer formed of Sb, and the dielectric layer are sequentially stacked on the recording layer, laser light is radiated to induce reaction and diffusion in the recording layer and the protective dielectric layer and a change in a crystalline structure of the mask layer, so that information can be reproduced from the recording medium regardless of a diffraction limit.

21. The method of claim 15, wherein, when a protective dielectric layer, a mask layer formed of AgOₓ, and the dielectric layer are sequentially stacked on the recording layer, laser light is radiated to induce reaction and diffusion in the recording layer and the protective dielectric layer and decompose the mask layer, so that information can be reproduced from the recording medium regardless of a diffraction limit.

22. The method of claim 15, wherein the recording layer and the dielectric layer are simultaneously formed, so that the recording layer and the dielectric layer have a mixed structure including materials for the recording layer and the dielectric layer,

23. A recording medium comprising:
a recording layer and a dielectric layer having absorption coefficients of optical constants using laser induced reaction and diffusion.

24. The recording medium of claim 23, wherein the recording layer is formed of a rare earth transition metal.

25. The recording medium of claim 24, wherein the rare earth transition metal is TbFeCo.

26. The recording medium of claim 23, wherein the recording layer is formed of alloys of rare earth metal and transition metal.

27. The recording medium of claim 23, wherein the reaction and diffusion are induced at a temperature of 490-580° C.

28. The recording medium of claim 23, wherein the dielectric layer is constructed as a sequential stack of a protective dielectric layer, a mask layer formed of Sb, and the dielectric layer formed on the recording layer, and laser light is radiated to induce reaction and diffusion in the recording layer and the protective dielectric layer and change a crystalline structure of the mask layer, so that information can be reproduced from the recording medium regardless of a diffraction limit.

29. The recording medium of claim 1, wherein the dielectric layer is constructed as a sequential stack of a protective dielectric layer, a mask layer formed of AgOₓ, and the dielectric layer formed on the recording layer, and laser light is radiated to induce reaction and diffusion in the recording layer and the protective dielectric layer and decompose the mask layer, so that information can be reproduced from the recording medium regardless of a diffraction limit.

30. The recording medium of claim 23, wherein the recording layer and the dielectric layer are simultaneously formed, so that the recording layer and the dielectric layer have a mixed structure including materials for the recording layer and the dielectric layer.

31. A recording medium comprising:
a recording layer and a dielectric layer, wherein the recording layer has a material with a changeable magnetic spin while the recording layer and the dielectric layer of the recording medium are irradiated with laser inducing reaction and diffusion of the recording medium.

32. The recording medium of claim 31, wherein the recording layer and the dielectric layer are simultaneously formed, so that the recording layer and the dielectric layer have a mixed structure including materials for the recording layer and the dielectric layer.

33. The recording medium of claim 31, wherein the recording layer is formed of a rare earth transition metal.

34. The recording medium of claim 33, wherein the rare earth transition metal is TbFeCo.

35. The recording medium of claim 31, wherein the recording layer is formed of alloys of rare earth metal and transition metal.

36. The recording medium of claim 31, wherein the reaction and diffusion are induced at a temperature of at or between 400 and 490° C.

37. A recording medium on which data is recorded comprising:
a recording layer and a dielectric layer, the recording layer having protruding record marks formed by laser inducing reaction and diffusion in the recording layer and the dielectric layer.

38. The recording medium of claim 37, wherein the recording layer is formed of a rare earth transition metal.

39. The recording medium of claim 38, wherein the rare earth transition metal is TbFeCo.

40. The recording medium of claim 37, wherein the recording layer is formed of alloys of rare earth metal and transition metal.

41. The recording medium of claim 37, wherein the reaction and diffusion are induced at a temperature of at or between 400 and 490° C.

42. The recording medium of claim 37, wherein the dielectric layer is constructed as a sequential stack of a protective dielectric layer, a mask layer made of Sb, and a dielectric layer formed on the recording layer, and laser light is radiated to induce reaction and diffusion in the recording layer and the protective dielectric layer and change a crystalline structure of the mask layer, so that information can be reproduced from the recording medium regardless of a diffraction limit.

43. The recording medium of claim 37, wherein the dielectric layer is constructed as a sequential stack formed of a protective dielectric layer, a mask layer made of AgOₓ, and the dielectric layer formed on the recording layer, and laser light is radiated to induce reaction and diffusion in the recording layer and the protective dielectric layer and decompose the mask layer, so that information can be reproduced from the recording medium regardless of a diffraction limit.

44. The recording medium of claim 37, wherein the recording layer and the dielectric layer are simultaneously formed, so that the recording layer and the dielectric layer have a mixed structure including materials for the recording layer and the dielectric layer,

45. An apparatus for recording and/or reproducing information with respect to a recording medium comprising:
a controller to transfer data with respect to the recording medium using a phase change method; and
a light source controlled by the controller to change absorption coefficients of optical constants of a recording layer and a dielectric layer of the recording medium by a laser induced reaction and diffusion and reproducing the recorded information from the recording medium.

46. The apparatus of claim 45, wherein the recording layer of the recording medium is formed of a rare earth transition metal.

47. The apparatus of claim 46, wherein the rare earth transition metal is TbFeCo.

48. The apparatus of claim 45, wherein the recording layer of the recording medium is formed of alloys of rare earth metal and transition metal.

49. The apparatus of claim 45, wherein the reaction and diffusion in the recording medium are induced at a temperature of at or between 490- and 580° C.

50. The apparatus of any claim 45, wherein, when the dielectric layer of the recording medium is constructed as a sequential stack of a protective dielectric layer, a mask layer made of Sb, and the dielectric layer formed on the recording layer, information is recorded by laser irradiation inducing reaction and diffusion in the recording layer and the protective dielectric layer and changing a crystalline structure of the mask layer, so that the recorded information can be reproduced regardless of a diffraction limit.

51. The apparatus of claim 45, wherein, when the dielectric layer of the recording medium is constructed as a sequential stack of a protective dielectric layer, a mask layer formed of AgOₓ, and the dielectric layer formed on the recording layer, information is recorded by laser irradiation inducing reaction and diffusion in the recording layer and the protective dielectric layer and decomposing the mask layer, so that the recorded information can be reproduced regardless of a diffraction limit.

52. The apparatus of claim 45, wherein the recording layer and the dielectric layer are simultaneously formed, so that the recording layer and the dielectric layer have a mixed structure including materials for the recording layer and the dielectric layer.

53. An apparatus for recording and/or reproducing information on a recording medium comprising:
a controller to transfer data with respect to the recording medium using a magneto-optical method; and
a light source controlled by the controller to change a magnetic spin direction in a recording layer while the recording layer and a dielectric layer of the recording medium are irradiated with a laser to induce reaction and diffusion therein and reproducing the recorded information from the recording medium.

54. The apparatus of claim 53, wherein the recording layer and the dielectric layer of the recording medium are simultaneously formed, so that the recording layer and the dielectric layer have a mixed structure including materials for the recording layer and the dielectric layer.

55. The apparatus of claim 53, wherein the recording layer of the recording medium is formed of a rare earth transition metal.

56. The apparatus of claim 55, wherein the rare earth transition metal is TbFeCo.

57. The apparatus of claim 53, wherein the recording layer of the recording medium is formed of alloys of rare earth metal and transition metal.

58. The apparatus of claim 53, wherein the reaction and diffusion in the recording medium are induced at a temperature of 400-490° C.

59. An apparatus for recording information on a recording medium using physical properties of protruding record marks formed by a laser on the recording medium comprising:
a controller to transfer data with respect to the recording medium using the physical properties; and
a light source controlled by the controller to induce reaction and diffusion in a recording layer and a dielectric layer and reproducing the recorded information from the recording medium.

60. The apparatus of claim 59, wherein the recording layer of the recording medium is formed of a rare earth transition metal.

61. The apparatus of claim 60, wherein the rare earth transition metal is TbFeCo.

62. The apparatus of claim 59, wherein the recording layer of the recording medium is formed of alloys of rare earth metal and transition metal.

63. The apparatus of claim 59, wherein the reaction and diffusion in the recording medium are induced at a temperature of at or between 400- and 490° C.

64. The apparatus of claim 59, wherein, when the dielectric layer of the recording medium is constructed as a sequential stack of a protective dielectric layer, a mask layer made of Sb, and the dielectric layer formed on the recording layer, information is recorded by laser irradiation inducing reaction and diffusion in the recording layer and the protective dielectric layer and changing a crystalline structure of the mask layer, so that the recorded information can be reproduced regardless of a diffraction limit.

65. The apparatus of claim 59, wherein, when the dielectric layer of the recording medium is constructed as a sequential stack of a protective dielectric layer, a mask layer made of AgOₓ, and the dielectric layer formed on the recording layer, information is recorded by laser irradiation inducing reaction and diffusion in the recording layer and the protective dielectric layer and decomposeing the mask layer, so that the recorded information can be reproduced regardless of a diffraction limit.

66. The apparatus of claim 59, wherein the recording layer and the dielectric layer are simultaneously formed, so that the recording layer and the dielectric layer have a mixed structure including materials for the recording layer and the dielectric layer.

67. A recording medium comprising:
a reflective layer;
a first dielectric layer formed on the reflective layer;
a recording layer formed on the dielectric layer;
a second dielectric layer formed on the recording layer; and
a transparent polycarbonate layer formed on the second dielectric layer, wherein the recording layer forms sulfides or oxides when heated by a laser beam.

68. The recording medium of claim 67, wherein the recording layer is heated to a temperature of at or between 400 and 490° C.

69. The recording medium of claim 67, wherein the recording layer is irradiated with a red or a blue laser beam.

70. The recording medium of claim 67, wherein the recording layer is a magnetic recording layer.

71. The recording medium of claim 67, wherein the recording layer is formed of a rate earth transition metal.

72. The recording medium of claim 71, wherein the rare earth transition metal is TbFeCo.
